(19) United States
(12) Patent Application Publication
(10) Pub. No.: US 2017/0087507 A1
(43) Pub. Date: Mar. 30, 2017

(54) TAIL GAS TREATMENT DEVICE AND TAIL GAS TREATMENT METHOD

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Jianhui LIU, Beijing (CN); Fu CHEN, Beijing (CN); Ying ZHANG, Beijing (CN); Rong SHEN, Beijing (CN); Yadong WANG, Beijing (CN); Zhongbao WANG, Beijing (CN); Ziheng YANG, Beijing (CN); Daeho OH, Beijing (CN); Zuhong LIU, Beijing (CN)

(21) Appl. No.: 15/160,664

(22) Filed: May 20, 2016

(30) Foreign Application Priority Data
Sep. 25, 2015 (CN) 201510624320.9

(51) Int. Cl. B01D 53/14; B01D 53/18

(52) U.S. Cl. CPC B01D 53/1493; B01D 53/18; B01D 2252/103

(57) ABSTRACT

The invention relates to a tail gas treatment device and a tail gas treatment method. The tail gas treatment device comprises: a gas inlet; a gas circulation passage connected with the gas inlet; a first water orifice used for spraying water to the tail gas in the gas circulation passage; a waste water pool used for accommodating waste water generated from treating the tail gas; a gas outlet; a water quality detection unit used for detecting water quality of waste water in the waste water pool; a drainage port used for draining waste water in the waste water pool; and a water return port connected with the first water orifice via a water return pipeline, and used for delivering water in the waste water pool to the first water orifice when the water quality of the water in the waste water pool meets a recycling requirement.

### FIELD OF THE INVENTION

The present invention relates to the field of tail gas treatment technology, and particularly relates to a tail gas treatment device and a tail gas treatment method.

### BACKGROUND OF THE INVENTION

Processes such as chemical vapor deposition, dry etching and the like need to be performed in the process of manufacturing a display panel. Tail gas will be generated in these processes. The tail gas needs to be treated before being discharged to atmosphere. For water-soluble gas, generally, it is removed by dissolving it in water.

A tail gas treatment device for water-soluble gas in the prior art generally includes a gas inlet, a gas circulation passage, a water orifice, a waste water pool and a gas outlet. The gas inlet is connected with a process cavity, and tail gas generated in the process cavity enters the gas circulation passage of the tail gas treatment device via the gas inlet. The water orifice is positioned in the side wall of the gas circulation passage, and water can be sprayed into the gas circulation passage via the water orifice, so as to dissolve water-soluble gas in the tail gas in water. Waste water containing the water-soluble gas flows into the waste water pool, and the tail gas from which the water-soluble gas has been removed is discharged from the gas outlet or subjected to other treatment.

When the tail gas treatment device in the prior art is used for treating the water-soluble gas, water is always sprayed into the gas circulation passage via the water orifice at a fixed flow rate, regardless of the quantity of the tail gas generated in the process cavity. Thus, when a little tail gas is generated in the process cavity, much water is wasted. Moreover, when treating the water-soluble gas, all the water in the waste water pool is discharged regardless of quality of water in the waste water pool. Thus, even if the quality of water in the waste water pool is good, the water will not be reused, which further causes waste.

### SUMMARY OF THE INVENTION

In order to solve at least one of the technical problems in the prior art, the present invention provides a tail gas treatment device and a tail gas treatment method capable of recycling waste water, reducing consumption of water resources and improving utilization rate of water resources.

According to one aspect of the present invention, there is provided a tail gas treatment device, including: a gas inlet, through which tail gas enters the tail gas treatment device; a gas circulation passage connected with the gas inlet; a first water orifice used for spraying water to the tail gas in the gas circulation passage; a waste water pool used for accommodating waste water generated from treating the tail gas; a gas outlet, through which the treated tail gas is discharged, the gas outlet being connected with the gas circulation passage and positioned at the tail end of the gas circulation passage; a water quality detection unit used for detecting whether water quality of waste water in the waste water pool meets a recycling requirement; a drainage port used for draining the waste water in the waste water pool; and a water return port connected with the first water orifice via a water return pipeline, and used for delivering water in the waste water pool to the first water orifice via the water return pipeline when the water quality of the waste water in the waste water pool meets the recycling requirement.

According to an embodiment of the present invention, the tail gas treatment device may further include a water level detection unit used for detecting water level of the waste water in the waste water pool.

According to an embodiment of the present invention, a filter device may be arranged at the water return port.

According to an embodiment of the present invention, the filter device may be a filter screen.

According to an embodiment of the present invention, water sprayed from the first water orifice may be in mist state.

According to an embodiment of the present invention, the tail gas treatment device may further include a second water orifice used for spraying water to the gas inlet and inner wall of the gas circulation passage.

According to an embodiment of the present invention, gas pressure detection devices may be arranged at the gas inlet and the gas outlet, respectively.

According to another aspect of the present invention, there is provided a tail gas treatment method including: S1, spraying water to tail gas, so that water-soluble substances in the tail gas are dissolved in water; S2, determining whether water quality of generated waste water meets a recycling requirement; and S3, if the water quality of the waste water meets the recycling requirement, delivering the waste water to a water orifice; if the water quality of the waste water does not meet the recycling requirement, discharging the waste water.

According to an embodiment of the present invention, the tail gas treatment method may further include detecting water level of waste water after step S1, and performing step S2 once the water level of the waste water reaches a preset water level.

According to an embodiment of the present invention, the tail gas treatment method may further include detecting pressure at the gas inlet and pressure at the gas outlet, and when the pressure at the gas inlet is lower than that at the gas outlet, water is sprayed to the inner wall of the gas circulation passage.

According to the tail gas treatment device and the tail gas treatment method provided by the present invention, a water quality detection unit is arranged in the waste water pool to execute the step of detecting water quality of the waste water. When the water quality of the waste water meets the recycling requirement, the waste water in the waste water pool is delivered to the first water orifice, so that reutilization of the waste water is realized, waste can be reduced and the cost can be reduced.

### BRIEF DESCRIPTION OF THE DRAWINGS

The accompanying drawings, which constitute a part of the description, are used for providing further understanding of the present invention, and explaining the present invention together with the following specific embodiments, rather than limiting the present invention. In the drawings:

FIG. 1 is a schematic diagram of a tail gas treatment device according to an embodiment of the present invention;

FIG. 2 is a schematic diagram of a process treatment using a vacuum cavity;

FIG. 3 is a schematic diagram illustrating a position of the tail gas treatment device in production line equipment; and

FIG. 4 is a flowchart of a tail gas treatment method according to an embodiment of the present invention.

### DESCRIPTION OF THE PREFERRED EMBODIMENT

The specific embodiments of the present invention will be described in detail below in combination with the accompanying drawings. It should be understood that, the specific embodiments described herein are merely used for describing and interpreting the present invention, rather than limiting the present invention.

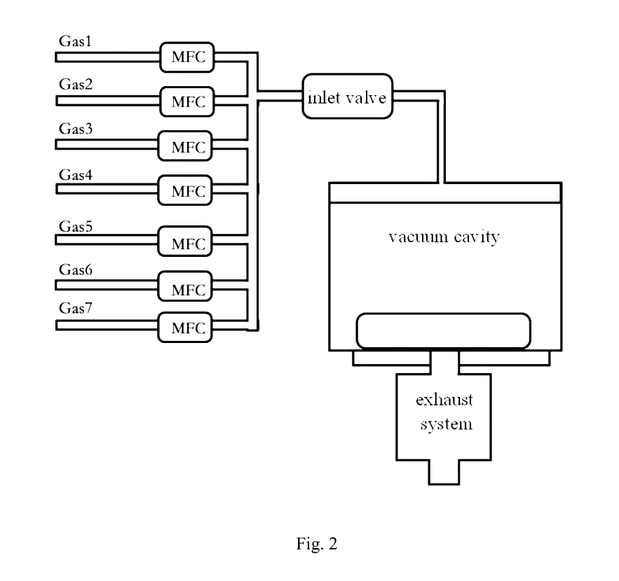

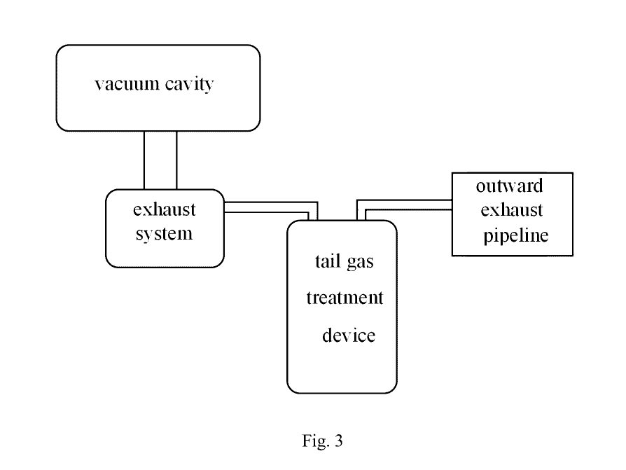

Processes such as chemical vapor deposition, dry etching and the like needs to be performed in the process of manufacturing a display panel. As shown in FIG. 2, process gas, e.g., at least one of process gas 1 to process gas 7 shown in FIG. 2, needs to be introduced into a vacuum cavity during these processes. A mass flow controller (MFC) is arranged on a ventilation duct to control flow rate of the process gas entering the vacuum cavity. After the processes, the process gas may be changed into waste gas and/or other products, and the waste gas is exhausted by an exhaust system. As shown in FIG. 3, the waste gas enters a tail gas treatment device, and is discharged to the outside via an outward exhaust pipeline after being treated.

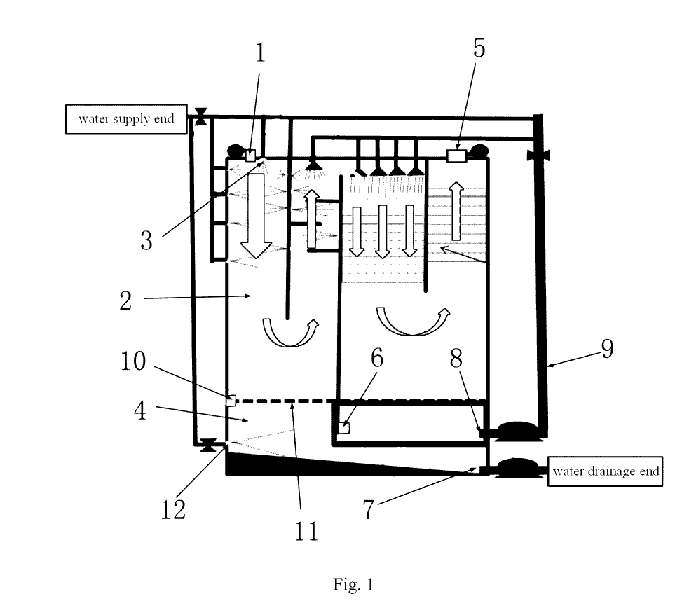

FIG. 1 is a schematic diagram of a tail gas treatment device according to an embodiment of the present invention. As shown in FIG. 1, the tail gas treatment device according to the embodiment of the present invention includes a gas inlet 1, a gas circulation passage 2, a first water orifice 3, a waste water pool 4, a gas outlet 5, a water quality detection unit 6, a drainage port 7 and a water return port 8.

Tail gas enters the tail gas treatment device via the gas inlet 1. The gas inlet 1 is connected with a process cavity where waste gas (or tail gas) is generated via the exhaust system (see FIG. 3). The gas circulation passage 2 is connected with the gas inlet 1. The first water orifice 3 is positioned on the side wall of the gas circulation passage 2, and sprays water to the tail gas in the gas circulation passage 2. The waste water pool 4 is used for accommodating waste water generated from treating the tail gas. The waste water pool 4 is positioned at the bottom of the gas circulation passage 2. The gas outlet 5 is connected to the outward exhaust pipeline (see FIG. 3). The treated tail gas is discharged from the gas outlet 5. The gas outlet 5 is connected with the gas circulation passage 2 and positioned at the tail end of the gas circulation passage 2. The water quality detection unit 6 is arranged in the waste water pool 4, and is used for detecting water quality of waste water in the waste water pool 4 and determining whether the water quality meets a recycling requirement. The drainage port 7 is positioned at the bottom of the waste water pool 4, and is used for draining the waste water in the waste water pool 4. The water return port 8 is positioned in the waste water pool 4, and is connected with the first water orifice 3 via a water return pipeline 9. When the water quality of the waste water in the waste water pool 4 meets the recycling requirement, the water return port 8 delivers the water in the waste water pool 4 to the first water orifice 3 via the water return pipeline 9.

According to the embodiment of the present invention, waste gas (or tail gas) generated in the process cavity enters the gas circulation passage 2 via the gas inlet 1. The first water orifice 3 sprays water into the gas circulation passage 2, e.g., sprays water in the form of mist, to better absorb water-soluble gas in the waste gas. In the gas circulation passage 2, the water-soluble gas in the waste gas is dissolved in water. The treated tail gas is discharged to the outside via the gas outlet 5, or enters other treatment equipment for retreatment. The generated waste water containing the water-soluble gas flows into the waste water pool 4. According to an embodiment of the present invention, a drying zone or a condensing zone may be formed in the gas circulation passage 2, so that water in the gas circulation passage 2 is changed into liquid and finally flows into the waste water pool 4.

The water quality detection unit 6 detects the water quality of the waste water flowing into the waste water pool 4. When the detected water quality is relatively good and meets the recycling requirement, the waste water in the waste water pool 4 is delivered to the first water orifice 3 via the water return pipeline 9 (by adopting a water pump or the like) for recycling. When the detected waste quality is relatively bad and does not meet the recycling requirement, the waste water in the waste water pool 4 is discharged from the drainage port 7.

According to an embodiment of the present invention, when the waste water in the waste water pool 4 is delivered to the first water orifice 3 via the water return port 8 and the water return pipeline 9, water supply to the first water orifice 3 can be reduced, or stopped. In this case, the water supply is reduced, and the tail gas treatment device can run in a water-saving mode. When the water quality in the waste water pool 4 finally becomes worse and does not meet the recycling requirement, the waste water in the waste water pool 4 is drained to the outside via the drainage port 7, and the water supply to the first water orifice 3 is simultaneously restored. In this case, the tail gas treatment device can run in a normal working mode, until the water quality in the waste water pool 4 is good enough for the tail gas treatment device to enter the water-saving mode.

The water quality detection unit 6 arranged in the waste water pool 4 is used for detecting the water quality of the waste water in the waste water pool 4. When the water quality of the waste water meets the recycling requirement, the waste water in the waste water pool 4 is delivered to the first water orifice 3, thereby achieving reutilization of the waste water, which can reduced waste and help to lower the cost.

According to an embodiment of the present invention, the tail gas treatment device may further include a water level detection unit 10, which is used for detecting water level of water in the waste water pool 4. It could be understood that, waste water continuously flows into the waste water pool 4, and the water quality of the waste water flowing into the waste water pool 4 changes greatly, so the water quality of the waste water in the waste water pool 4 always changes dynamically. Thus, in practical application, it is difficult to perform a water drainage operation or a water return operation in real time according to the change in water quality of the waste water in the waste water pool 4. Moreover, when the water quantity in the waste water pool 4 is small, the real-time water return operation may cause high energy consumption. By using the water level detection unit 10 to detect the water level of the waste water in the waste water pool 4, water quality detection may be performed only after the water level of the waste water in the waste water pool 4 reaches a preset water level, and whether to perform the water drainage operation via the drainage port 7 or the water return operation via the water return port 8 is determined according to the result of the water quality detection.

It could be understood that, some components in the waste gas may become solid substances such as crystal and the like in water, and the solid substances may be attached to the side wall of the gas circulation passage 2 or fall into the waste water pool 4. According to an embodiment of the present invention, a filter device may be arranged at the water return port 8 to filter possible crystal in the waste water pool 4, thus preventing the crystal from being absorbed into the water return pipeline 9 and delivered to the first water orifice 3 to block the first water orifice 3. According to an embodiment of the present invention, the filter device may be a filter screen 11.

In addition, a second water orifice 12 may be formed in the side wall of the gas circulation passage 2, and is used for spraying water to the gas inlet 1 and the inner wall of the gas circulation passage 2 to wash the same, so as to clean the side wall of the gas circulation passage 2. It could be understood that, the second water orifice 12 sprays water outwards with high water pressure.

When the treating speed of the tail gas treatment device on waste gas is lower than the generating speed of waste gas in the process cavity, the pressure of waste gas in the tail gas treatment device may be high, and crystals are accumulated to block the gas inlet 1, and even cause failure of the tail gas treatment device. In this case, process equipment must stop and wait for the tail gas treatment device to treat the waste gas, and the crystals accumulated in the gas inlet 1 and the gas circulation passage 2 need to be cleaned, which lowers the activation of the process equipment.

According to an embodiment of the present invention, when crystals are accumulated on the side wall of the gas circulation passage 2, the second water orifice 12 may automatically clean the side wall of the gas circulation passage 2, and then the process equipment does not need to stop, so that the activation of the process equipment can be improved.

Gas pressure detection devices (not shown in the figures) may be arranged at the gas inlet 1 and the gas outlet 5, respectively, to detect the gas pressures at the gas inlet 1 and the gas outlet 5. Generally, accumulation of crystals in the gas circulation passage 2 may cause the gas pressure at the gas inlet 1 to be lower than that at the gas outlet 5, so that waste gas can hardly flow from the gas inlet 1 to the gas outlet 5, and some untreated waste gas is likely to leak, so as to cause environmental pollution and harm the health of workers. According to the embodiment of the present invention, the gas pressure detection devices detect the gas pressures at the gas inlet 1 and the gas outlet 5, and when the gas pressure at the gas inlet 1 is lower than that at the gas outlet 5, the second water orifice 12 may be automatically started, so that the tail gas treatment device enters an automatic cleaning mode. The second water orifice 12 sprays water to scour off the crystals accumulated in the gas inlet 1 and the gas circulation passage 2, so as to cause the gas pressure at the gas inlet 1 to be higher than that at the gas outlet 5.

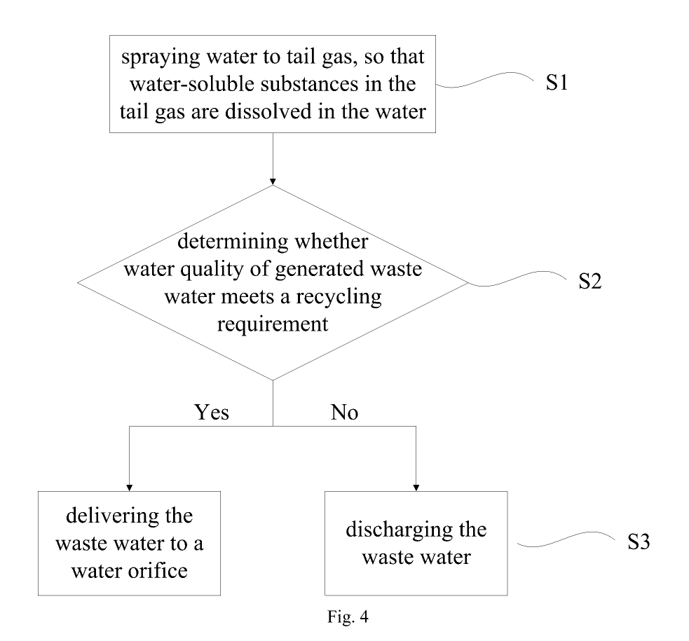

FIG. 4 is a flowchart of a tail gas treatment method according to an embodiment of the present invention. As shown in FIG. 4, the tail gas treatment method according to the embodiment of the present invention includes:

S1, spraying water to tail gas, so that water-soluble substances in the tail gas are dissolved in water;

S2, determining whether water quality of generated waste water meets a recycling requirement; and

S3, if the water quality of the waste water meets the recycling requirement, delivering the waste water to a water orifice; if the water quality of the waste water does not meet the recycling requirement, discharging the waste water.

In step S3, when the water quality of the waste water meets the recycling requirement, the waste water is delivered to the water orifice. At the moment, the water supply to the water orifice may be reduced or stopped, so as to reduce water consumed for treating tail gas, that is, a water-saving working mode is enabled. When the water quality of the waste water does not meet the recycling requirement, the water supply to the water orifice is restored, that is, a normal working mode is enabled.

It could be understood that, the water-saving working mode and the normal working mode may alternate. First, in the normal working mode, when the quantity of tail gas is small or the water yield of the water orifice is high, the water quality of waste water is relatively good, so that the recycling requirement is met, and the water-saving working mode is enabled; subsequently, in the water-saving working mode, waste water is recycled, and the water quality thereof continuously gets worse, so that the recycling requirement cannot be met, and the normal working mode is enabled again.

According to an embodiment of the present invention, after step Si and before step S2, the tail gas treatment method may further include:

detecting water level of waste water, and performing step S2 once the water level of the waste water reaches a preset water level.

It could be understood that, waste water is continuously generated, and the water quality of the continuously generated waste water changes greatly, so the water quality of the waste water always changes dynamically. Thus, in practical application, it is difficult to perform a water drainage operation or a water return operation in real time according to the change in water quality of the waste water. Moreover, in the case of small quantity of waste water, the real-time water return operation may cause high energy consumption. In addition, in the case of small quantity of waste water, even if the water return operation is enabled, the water-saving working mode cannot be maintained, so that the normal working mode and the water-saving working mode are switched frequently, which is unfavourable for optimization of the process. Water quality detection is performed only after the water level of the waste water reaches the preset water level, and whether to perform the water drainage operation or the water return operation is determined according to the result of the water quality detection.

According to an embodiment of the present invention, the tail gas treatment method may further include: detecting the pressure at the gas inlet and the pressure at the gas outlet, and spraying water to the inner wall of the gas circulation passage when the pressure at the gas inlet is lower than the pressure at the gas outlet.

When the pressure at the gas inlet is lower than the pressure at the gas outlet, water may be sprayed onto the inner wall of the gas circulation passage to scour off attachments on the inner wall. In this way, the tail gas treatment device enters an automatic cleaning mode, so as to avoid failure of the device and leakage of untreated waste gas, so that the activation of the process equipment can be improved.

It could be understood that, the above embodiments are merely exemplary embodiments adopted for describing the principle of the present invention, but the present invention is not limited thereto. Various variations and improvements may be made by those of ordinary skill in the art without departing from the spirit and essence of the present invention, and these variations and improvements shall fall into the protection scope of the present invention.

1. A tail gas treatment device, comprising:
a gas inlet, through which tail gas enters the tail gas treatment device;
a gas circulation passage connected with the gas inlet;
a first water orifice used for spraying water to the tail gas in the gas circulation passage;
a waste water pool used for accommodating waste water generated from treating the tail gas;
a gas outlet, through which the treated tail gas is discharged, the gas outlet being connected with the gas circulation passage and positioned at a tail end of the gas circulation passage;
a water quality detection unit used for detecting water quality of waste water in the waste water pool and determining whether the water quality meets a recycling requirement;
a drainage port used for draining the waste water in the waste water pool; and
a water return port connected with the first water orifice via a water return pipeline, and used for delivering water in the waste water pool to the first water orifice via the water return pipeline when the water quality of the waste water in the waste water pool meets the recycling requirement.

2. The tail gas treatment device of claim 1, further comprising:
a water level detection unit used for detecting water level of the waste water in the waste water pool.

3. The tail gas treatment device of claim 1, wherein a filter device is arranged at the water return port.

4. The tail gas treatment device of claim 3, wherein the filter device is a filter screen.

5. The tail gas treatment device of claim 1, wherein water sprayed from the first water orifice is in mist state.

6. The tail gas treatment device of claim 1, further comprising:
a second water orifice used for spraying water to the gas inlet and inner wall of the gas circulation passage.

7. The tail gas treatment device of claim 1, wherein gas pressure detection devices are arranged at the gas inlet and the gas outlet, respectively.

8. A tail gas treatment method, comprising:
S1, spraying water to tail gas, so that water-soluble substances in the tail gas are dissolved in water;
S2, determining whether water quality of generated waste water meets a recycling requirement; and
S3, if the water quality of the waste water meets the recycling requirement, delivering the waste water to a water orifice; if the water quality of the waste water does not meet the recycling requirement, discharging the waste water.

9. The tail gas treatment method of claim 8, further comprising:
detecting water level of waste water after step S1, and performing step S2 once the water level of the waste water reaches a preset water level.

10. The tail gas treatment method of claim 8, further comprising:
detecting pressure at the gas inlet and pressure at the gas outlet, and
wherein when the pressure at the gas inlet is lower than the pressure at the gas outlet, water is sprayed to inner wall of a gas circulation passage.
